(19) United States
(12) Patent Application Publication
(10) Pub. No.: US 2005/0174091 A1
(43) Pub. Date: Aug. 11, 2005

(54) Method and system for sequential charging of multiple devices by a programmable power supply

(76) Inventors: Tal Dayan, Los Gatos, CA (US); Dan Kikinis, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/776,994

(22) Filed: Feb. 11, 2004

(51) Int. Cl. H02J 7/00

(52) U.S. Cl. 320/128

(57) ABSTRACT

An apparatus comprising a power supply and a charging sequence device. The charging sequence device configured to be connected to multiple rechargeable separate devices, and to charge the multiple rechargeable separate devices sequentially.

This application claims priority to related provisional application No. 60/446,597 filed Feb. 10, 2003 titled “Method and System For Sequential Charging of Multiple Devices By A Programmable Power Supply” (Attorney Docket No. 6041.P016z) and to related provisional application No. 60/446,423 filed Feb. 10, 2003 titled “Method and System For Powering Multiple Devices By A Programmable Power Supply” (Attorney Docket No. 6041.P017z).

### BACKGROUND

FIG. 1 shows a power supply 100 as known in current art. One example is described in detail in U.S. Pat. No. 6,266,261 and some related patents. In principle, programmable power supply 100 has a power cord 101 with an ac connector 102, an input port 103, an output port 111 with an extension cord 110 ending in special adaptor device 113 that connects to a cable through port 112 to a device such as a notebook, cell phone, PDA, or other similar device on the other side. Adaptor device 113 contains a set of resistors to program voltage and a current limit.

FIG. 2 shows examples 113a and 113b of different possible component configurations for a programmable power supply. Simple resistors are used to program the output voltage delivered, in this example on pin 2, with ground on pin 3. Also shown are the details of port 111, a four-pin port (pins 1-4) connecting to internal control device 201 that receives a voltage 202 from the rest of the power supply 100 and, according to which resistors are applied, delivers information back through connection 203. Connections are simplified in this example for reasons of clarity.

The problem with the above-described solution as currently practiced by those skilled in the art is that very often a user travels with multiple devices, such as a digital camera, notebook computer, a cell phone, and a PDA. In such cases, because the power supply can charge only one device at a time, the user must charge each device separately, unplugging any previously charged device and then plugging in another device and its adaptor, even though the power supply may be universally adaptable for all the user's devices. Thus a traveler who has used and discharged multiple devices during a busy day and who hopes to charge multiple devices during the night, must arise during the night each time one device is charged and the next device may be connected to the charger, with attendant switching of adaptors as required. What is clearly needed is a system and method that allows a user to connect all devices to a power supply at one time and leave them unattended, with an assurance that they will all charge properly after some suitable length of time (such as overnight).

In some cases a user may want to buy a new system rather than expand or extend an old system he already owns. A company called American Power Conversions has a product that they have just announced that can fulfill certain aspects of the novel art of this disclosure. However, careful study by one skilled in the art reveals that said product is limited to USB sourcing of the devices. This approach has the advantage that no new power supplies need to be developed; but rather, an existing USB charging cable may be adapted into a new application. The main disadvantage is that USB charge currents are very limited and may not be adequate for devices that require a higher voltage or higher power. This approach also may require a notebook computer to be available to convert the higher voltage of the power supply to the USB voltage used by the USB charging cables, which are widely used.

What is clearly needed is a system and a method for a novel type of power supply to create a power bus that allows multiple devices to be powered from one cable, all at the same time, by sequencing the distribution of power to the various devices and blocking off devices that aren't ready to receive power yet.

### SUMMARY

An apparatus comprising a power supply and a charging sequence device. The charging sequence device configured to be connected to multiple rechargeable separate devices, and to charge the multiple rechargeable separate devices sequentially.

### BRIEF DESCRIPTION OF THE DRAWINGS

FIG. 1 shows a power supply 100 as known in current art.

FIG. 2 shows examples of different possible component configurations for a programmable power supply;

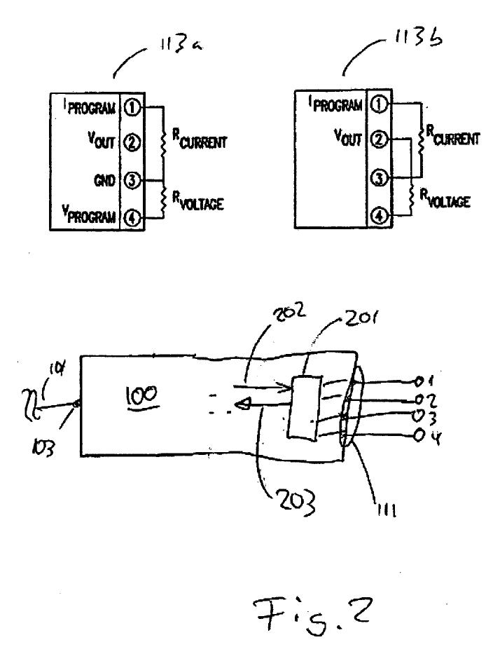

FIG. 3 shows one approach for unattended, sequential charging of multiple devices by one power supply;

FIG. 4 shows an integrated sequencer in a power supply

FIG. 5 shows a multiple-device power unit; and

FIG. 6 shows an example of a power arbitration procedure.

### DESCRIPTION OF THE EMBODIMENT

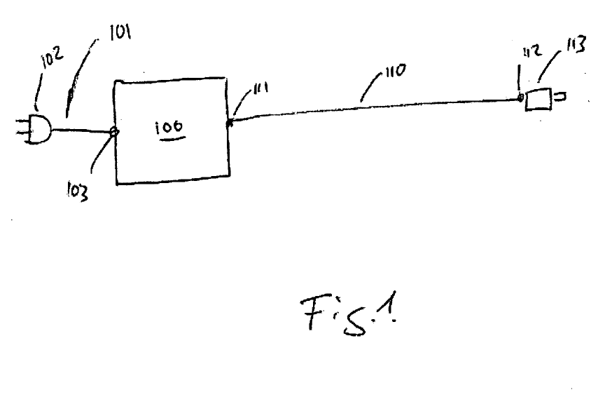

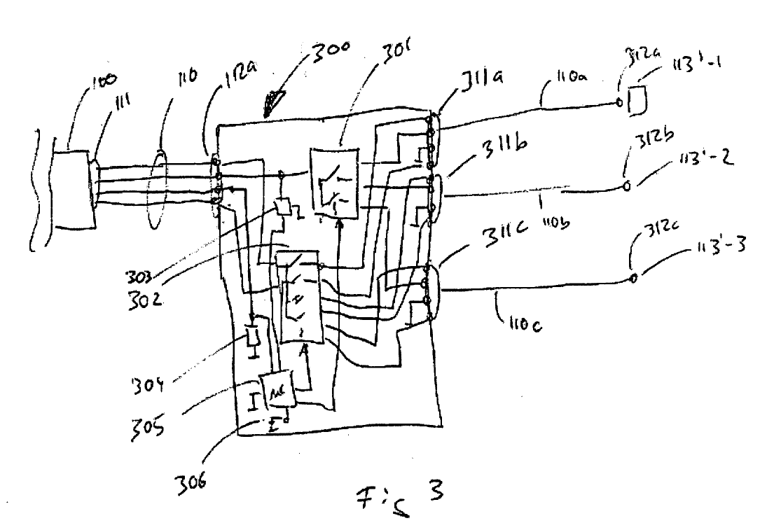

FIG. 3 shows one approach for unattended, sequential charging of multiple devices by one power supply, according to the novel art of this disclosure. A charging sequencer device 300 connects at the end of cable 1 10 coming from power supply 100, as shown in FIG. 1. Device 300 contains a power-switching array 301 for connecting the power coming in on port 112a to one of the output ports 311a, b, or c. It also contains analog switching array 302 to pass through the resistor values it sees from the tips 113′-1, -2, and -3 through cables 110a-c and passes them through the analog switch 302 back into cable 110 leading into the power supply 100. Thus each device connected to device 300 is ensured of receiving its correct voltage. In some cases, it may be necessary to take care that in the transition between devices, the new voltage stabilizes without exceeding the voltage range of the next device. For example, one solution could be to first connect the resistors and then the Vout. Another solution could be to let the Vout stabilize to the new voltage from an initial safe low voltage. Also, in some cases resistors and capacitors, or even negative resistors (using operational amplifiers to compensate for losses) may be added for better results. Many variations of dedicated hardware (not shown) may be added to improve functionality without departing from the-spirit of the present invention.

The charge sequencing is done by microcontroller 305, sometimes in combination with dedicated hardware (not shown), typically some kind of embedded microcontroller as is well known in current art. A small added regulator 303 creates an internal supply voltage for microcontroller 305, because in some cases the input voltage may be too high for microcontroller 305 to operate directly from. Optional current sensing resistor 304 is also added in the ground pin of the input connector 112a, thus allowing the microcontroller to sense when a device has finished charging by observing a dramatic drop in the steady-state current. The microcontroller can then tell the charger 300 to revert to a trickle charge or pulse standby charge pattern. When the end of charging is thus recognized, charging power can be shifted to the next device, and so forth. When all the devices are charged, a trickle pattern can be implemented that, for example, gives each device 5 or 10 minutes of trickle charge and then switches to the next device.

In some cases (not shown), the microprocessor may also have sensing capabilities to detect insertion or removal of devices. In the simplest case, a current-sensing resistor may be used, as described above, but other detection methods could also be used. This approach typically would result more efficient operation, because unused branches would be skipped. This approach could also be used to supply state indications to the user interface. For example, an LED could indicate “Device 2 is plugged in and is waiting to be powered.” Also, various behavior and properties of the devices may be tracked and this information may be used for the power sequencing routine.

In some cases, the user may be offered the opportunity to input patterns of charging sequences among the various devices plugged into the charging sequencer device 300. In other cases, the charging sequence may simply start at the first port (e.g., port 311a) and proceed in order through the port sequence (e.g., port 311a to port 311b to port 311c). Thus the user can control the charging sequence by plugging devices into the ports in a specific order. Or there may be a user sequencing input 306, which may be as simple as a push-button, or it may be a more complex user interface (not shown), such as multiple push-buttons, selectors, LCDs, LED displays, audio indications, etc.

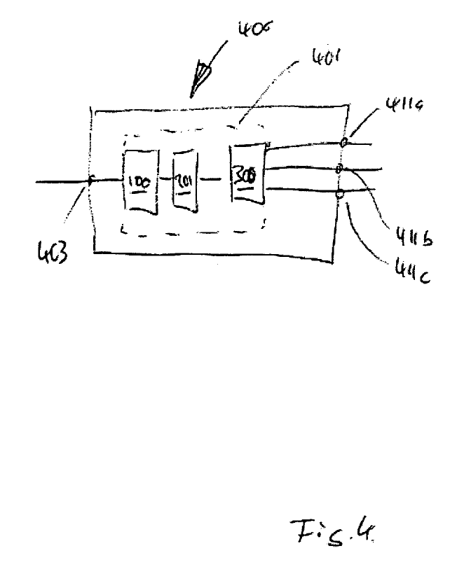

Sequencer 300 may be offered as an after-market upgrade for existing programmable power supplies of the type described in the background section of this disclosure. However, in other cases, the sequencer may be integrated into a new power supply 400 as shown in FIG. 4. Power supply 400 in essence contains the building blocks of the original power supply 100, the programming controller 201, and the multiplexing device 300. It is clear that economies of materials and manufacturing effort may be achieved by integrating all functions into one unit.

Further, in some cases, the resistors and the ‘tips’ may be already embedded in the device and the device may have a standard universal power port. Also, doing the switching using a user control mechanical (e.g., rotary) switch to switch between devices may be implemented. In yet other cases, or in combination, the system may have the ability to charge multiple devices at the same time if they are using the same voltage. Such multiple device charging may be done by sensing the resistors and detection matches of voltage and total power. In some cases, the system may include other than just resistors for communicating the voltage and current requirements. Further, in some cases a method may be used wherein the microcontroller reads the device parameters and passes them onto the power supply (either in the same: format, such as resistance, or in a completely different format). In yet other cases, a multi level or modular system may be implemented, in which a sequencer (such as device 300) is installed at one of the branches of another sequencer. Further, a sequencer can be implemented where the input or output wires are automatically retraceable, or can be wound around the body of the sequencer, rather than just plugged in. Also, a sequencer can be made that is an add-on attachment to an existing power supply. Further, a sequencer might also have a container for storing the tips. In yet other cases, a sequencer may include various travel and other types of accessories (emergency light, alarm clock, smoke detector, etc.). A sequencer may also act as a battery charger. For example, the sequencer could have a place to insert two AA rechargeable batteries. In yet some cases, a sequencer may use a fixed voltage power supply, so it could then support either sequential or parallel powering of devices of the same voltage. For example, a manufacturer may use a standard 5V operating voltage for multiple products, so the sequencer could be used to charge all these devices sequentially.

In some cases, the LEDs or other indication can signal to a user so he can clearly see the status of each device. Further, specific information may be displayed for error conditions such as the voltage required by a device does not match the power supply capabilities, under/over voltage etc.; in yet other cases, in the sequencer voltage adjustment and splitting capabilities could be added, for example, having a DC/DC from the main rail such that a notebook and a PDA can charged at the same time.

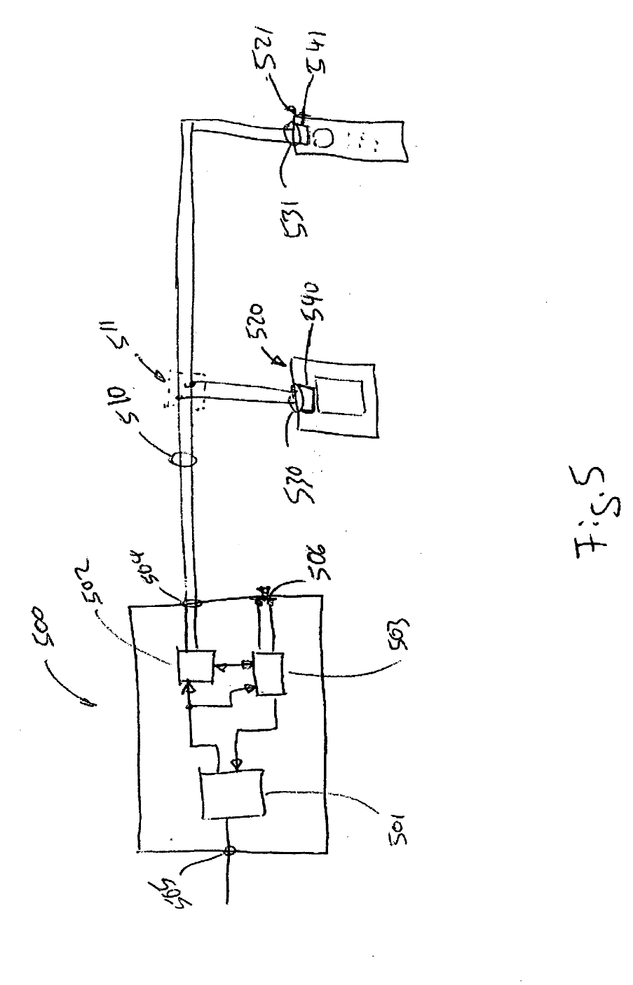

FIG. 5 shows a multiple-device power unit 500 according to the novel art-of the present disclosure. It includes a programmable power supply 501; microcontroller 503 capable of controlling programmable power supply 501 and also capable of interacting with data exchange module 502, which allows the exchange of data with devices or smart connectors connected to power bus cable 510. Also shown is a user interface 506. In FIG. 5, said user interface is represented simply by one push-button, but it is clear, as noted in co-pending application MW019, that said user interface may be more elaborate, including multiple buttons, keyboard, turn-wheels, LCDs, LEDs, etc. Also is the ac power input port 505, where primary power is delivered. Input power may be ac power only, or in some cases, it may be adapted to allow power input from alternate public power sources such as automobile batteries, airplane power, external battery(ies), solar panel, fuel cell etc. The output connector 504 has two wires in a cable 510 that basically comprise the power and ground; wherein the same technology is used as is described in prior co-pending applications attached as appendices A-P and incorporated herein.

In some cases, multiple paths (cables or busses) may exist, such as 510 and additionally 511, to simultaneously connect multiple devices such as PDA 520 and cell phone 521. Each of connected device has a two-pin connector or port, such as, in the cases of devices 520 and 521, ports 530 and 531, respectively. Devices such as 520 and 521 also need an intelligence control module such as modules 540 and 541, respectively, which may in some cases may be integrated into the device, as in a case where a device already contains a controller according to the novel art of prior co-pending applications In the case of a device not designed according to the novel art of said prior co-pending applications, the intelligence module, such as module 540 or 541, may be on a special connector port; or in yet other cases, said module may be contained in an adaptor device that adapts to the regular power connector of the device. The intelligence control module, such as modules 540 and 541, contains the circuitry that sends the device ID, its power requirements, and other similar power-related data to controller 503 in the power unit 500. The intelligence control module also can disconnect the device from the power bus 510 or 511 until it receives a signal from power unit 503 indicating that the correct voltage has been applied and now power for the device, such as device 520 or 521, is available.

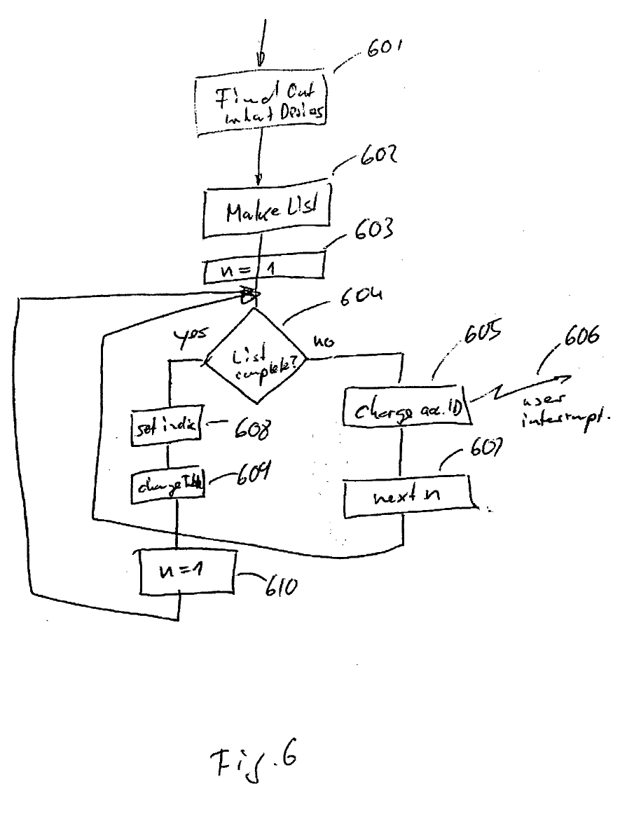

FIG. 6 shows a simplified example of a power arbitration procedure. In step 601, controller 503 queries connected devices to find out their device ID, power requirements, etc. Such inquiry protocols have been disclosed in prior co-pending applications Based on the data gathered in step 601, in step 602 controller 503 assembles a list of device priority of powering and how to supply power to each device. For example, there may be factory-preprogrammed priority, or the user could specify the device priority via user interface 506.

In step 603 a pointer n is set to the first device on the priority list; and in step 604 the list is checked to see that the charging of devices on the list is complete. In cases when the charging is not complete, the device with top priority is now charged in step 605. At any time during the charging in step 605, the user may interrupt by user input, as indicated by user interrupt vector 606. Once a device is fully charged, which is determined either by comparing the charge to the known device power requirements or because the charge current has dropped to trickle or standby level, the pointer moves in step 607 to the next device on the list, and the loop cycles.

When the list is run through and all devices are charged, the process branches to step 608,-where new parameters are established. Typically, the system would rotate trickle charge-time in shorter sequences for each device. For example, if the initial charge may take two hours per device, in step 608 the rotation of the list is adjusted for perhaps 5 to 10 minutes of trickle charging per device, in sequence.

There are limitless variations of the technical details of embodiments of this disclosure, all of which remain within the spirit of the novel art of this disclosure. Changes may be made in infrastructure, in wiring, in communication methods, in the setup, etc. As mentioned above, the device controllers, such as 540 and 541 (only two are shown for clarity and simplicity in this example), may be integrated into the device or may be in an adaptor connector.

Furthermore, the cable 510 may be just a one-to-one cable and the power supply may offer multiple ports that are connected in parallel internally, or in other cases, the cable at the device may have a daisy-chain port, allowing one to device to be plugged into another. Since the power supply can control and correct the voltage in communication with the device, allowance can be made for voltage drops along the line.

Further, as described earlier, functions like power bussing; i.e., power sharing between devices, data link such as sync, and many other variations are inherited from previous applications. Attached with the present application are Appendices A through P, which are incorporated herein by reference.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1) an apparatus comprising:
a power supply
a charging sequence device, coupled to the power supply, the charging sequence device configured to be connected to multiple rechargeable separate devices, and to charge the multiple rechargeable separate devices sequentially.

2) The apparatus of claim 1, wherein the power supply is programmable.

3) The apparatus of claim 2, wherein the charging sequence device is further configured to charge the multiple rechargeable separate devices sequentially with a different voltage level on the separate devices.

4) The apparatus of claim 3, wherein the power supply is a single power supply.

5) The apparatus of claim 4, wherein the charging sequence device comprises a single in port to receive power and multiple out ports to provide power to multiple rechargeable separate devices, and a switching array to pass through resistor values from connections to the multiple rechargeable devices to the power supply.

6) The apparatus of claim 4, wherein the charging sequence device further comprises a microcontroller configured to control the charge sequencing among the multiple rechargeable devices.

7) The apparatus of claim 6, wherein the microcontroller is further configured to sense when a rechargeable device is finished charging by observing a drop in a steady-state current, and in response the microcontroller is configured to shift charging to a separate rechargeable device.

8) The apparatus of claim 2, wherein the charging sequence device is further configured to query the multiple rechargeable separate devices connected to the charging sequence device to obtain information of each device to determine respective power requirements for the multiple rechargeable separate devices.

9) The apparatus of claim 2, wherein the charging sequence device is further configured to query the multiple rechargeable separate devices connected to the charging sequence device to obtain information of each device to generate device priority of powering among the multiple rechargeable separate devices.

10) The apparatus of claim 2, wherein the charging sequence device is further configured to block power to one of the multiple rechargeable devices that is not ready to receive power.
